(19) United States
(12) Patent Application Publication
(10) Pub. No.: US 2006/0075336 A1
(43) Pub. Date: Apr. 6, 2006

(54) Method, system and program product for providing content over a network

(75) Inventors: Helen L. Gawor, Apex, NC (US); John R. Hind, Raleigh, NC (US); Steven D. Ims, Cary, NC (US); Marcia L. Stockton, Bakersfield, CA (US)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 10/953,323

(22) Filed: Sep. 29, 2004

(51) Int. Cl. G06F 17/21; G06F 17/24; G06F 15/16

(52) U.S. Cl. 715/530; 715/513; 709/217

(57) ABSTRACT

An improved solution for providing content over a network is described. In particular, a tag is inserted into display content indicating slow-loading data that is to be incorporated. When the display content is requested, a placeholder is inserted into the display content in place of the tag and the display content is provided for display at a client. Subsequently, the slow-loading data can be obtained and incorporated into the display content, which can be provided for display at the client.

### BACKGROUND OF THE INVENTION

1. Technical Field

The invention relates generally to providing content over a network, and more particularly, to a solution for providing content that gives an end user a more responsive experience.

2. Background Art

Content, such as a web page, is increasingly provided over networks such as the Internet for display at a client. Many web pages are retrieved from a web server and displayed at the client with little or no required processing. As a result, a user at the client expects a particular time period within which a requested web page is obtained and displayed. When the requested web page is not displayed within the expected time period, the user will frequently attribute the delay to lost communications or a poor performing web server. In the former case, the user may re-request the web page in an attempt to reinitiate the communications, while in the latter case, the user may leave the web site and go to another web site. In either case, the user may have a poor impression of the web site.

However, the longer time period may be due to the inclusion of slow-loading data in the web page. For example, the web page may include data that must be retrieved from a database, data that must be compiled from multiple sources, data located at a remote server, or the like. In any event, the time required to access and compile the data for display at the client may be longer than the time period expected by the user. Further, the user does not necessarily have the ability to recognize the fact that slow-loading data is present. As a result, there is a need to provide the user a more responsive experience when display content (e.g., a web page) is requested that includes slow-loading data.

A current solution is to insert custom code into the display content that will insert a placeholder such as “Please wait, page is loading” in place of the slow-loading data. For example, the custom code can be written in a client-side scripting language (e.g., JavaScript) and/or server-side scripting language, which is included in a web page or the like. However, this code can be complex, and is often not reusable from one web page to another. Additionally, not all clients support or desire to support scripting language(s). In an alternative solution, the connection between a server and browser is left open, so that the browser can “push” the slow-loading data after it is received. However, this solution fails to provide the user any feedback while the slow-loading data is being received and requires specialized functionality in the browser for support.

In light of this, a need exists for an improved solution for providing content over a network. In particular, a need exists for a solution for providing feedback to a user on the status of requested display content without requiring the inclusion of custom code in the display content.

### SUMMARY OF THE INVENTION

The invention provides a solution for providing content over a network. Specifically, under the present invention, a client requests display content that includes slow-loading data. In response, temporary content such as a progress indication is generated and provided for display at the client while the slow-loading data is obtained and incorporated into the display content to generate complete content. Subsequently, the complete content is provided for display at the client. In one embodiment, an indicator is included in the temporary content, which instructs the client to generate an update request for the display content after a time period has elapsed.

A first aspect of the invention provides a method of providing content over a network, the method comprising: receiving display content over the network, wherein the display content includes a tag that indicates slow-loading data to be incorporated into the display content; generating temporary content by replacing the tag in the display content with a placeholder; and providing the temporary content for display at a client.

A second aspect of the invention provides a method of providing content over a network, the method comprising: receiving display content from a content provider, wherein the display content includes a tag that indicates slow-loading data to be incorporated into the display content; generating temporary content by replacing the tag in the display content with a placeholder; providing the temporary content over the network for display at a client; receiving the slow-loading data from a data source; generating complete content based on the display content and the slow-loading data; and providing the complete content over the network for display at the client.

A third aspect of the invention provides a system for providing content over a network, the system comprising: a display system for receiving display content over the network, wherein the display content includes a tag that indicates slow-loading data to be incorporated into the display content; a temporary content system for generating temporary content by replacing the tag in the display content with a placeholder; and an interface system for providing the temporary content for display at a client.

A fourth aspect of the invention provides a program product stored on a recordable medium for providing content over a network, the program product comprising: program code for receiving display content, wherein the display content includes a tag that indicates slow-loading data to be incorporated into the display content; program code for generating temporary content by replacing the tag in the display content with a placeholder; and program code for providing the temporary content over the network for display at a client.

A fifth aspect of the invention provides a method of deploying an application for providing content over a network, the method comprising: providing a computer infrastructure being operable to: receive display content, wherein the display content includes a tag that indicates slow-loading data to be incorporated into the display content; generate temporary content by replacing the tag in the display content with a placeholder; provide the temporary content over the network for display at a client; receive the slow-loading data; generate complete content based on the display content and the slow-loading data; and provide the complete content over the network for display at the client.

A sixth aspect of the invention provides computer software embodied in a propagated signal for providing content over a network, the computer software comprising instructions to cause a computer system to perform the following functions: receive display content, wherein the display content includes a tag that indicates slow-loading data to be incorporated into the display content; generate temporary content by replacing the tag in the display content with a placeholder; provide the temporary content over the network for display at a client; receive the slow-loading data; generate complete content based on the display content and the slow-loading data; and provide the complete content over the network for display at the client.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for providing content over a network according to one embodiment of the invention;

FIG. 2 shows a more detailed view of the surrogate shown in FIG. 1;

FIG. 3 shows an illustrative data flow diagram of the system shown in FIGS. 1 and 2; and

FIG. 4 shows method steps for processing a request for display content according to one embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a solution for providing content over a network. Specifically, under the present invention, a client requests display content that includes slow-loading data. In response, temporary content such as a progress indication is generated and provided for display at the client while the slow-loading data is obtained and incorporated into the display content to generate complete content. Subsequently, the complete content is provided for display at the client. In one embodiment, an indicator is included in the temporary content, which instructs the client to generate an update request for the display content after a time period has elapsed.

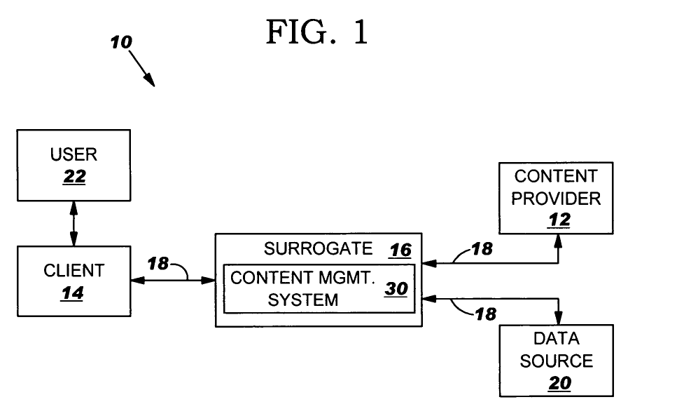

Turning to the drawings, FIG. 1 shows an illustrative system 10 for providing content over a network according to one embodiment of the invention. In particular, content provider 12 can provide display content to client 14 via a surrogate 16. Subsequently, client 14 can display the display content to user 22. For example, user 22 can operate a web browser or the like executing on client 14 to request display content from content provider 12. The request can be routed to surrogate 16 for processing. To this extent, surrogate 16 can include a content management system 30 that can obtain the display content from content provider 12, and perform any necessary processing before providing the display content for display at client 14. Surrogate 16 can implement any architecture, such as the Edge Side Includes (ESI) open standard, for processing requests for display content located at content provider 12.

For some display content, content management system 30 will need to obtain slow-loading data from data source 20 for inclusion in the display content. As used herein, the term “slow-loading data” means any data for which an expected time period for obtaining and/or processing the data for display at client 14 is anticipated to exceed an acceptable time period for user 22. For example, slow-loading data can comprise data that is remotely located from content provider 12 and/or surrogate 16 and is obtained over a network 18. Further, slow-loading data can comprise data that is obtained as a result of processing other data. In any event, the expected time period can be calculated based on a history of obtaining and/or processing the slow-loading data, while the acceptable time period can be a set time period such as ten seconds, a selectable time period, or the like.

Regardless, communications between each of the computing devices (e.g., content provider 12, client 14, surrogate 16, and/or data source 20) can occur over one or more networks 18. To this extent, network 18 can comprise any combination of various types of communications links. For example, network 18 can comprise addressable connections that may utilize any combination of wireline and/or wireless transmission methods. In this instance, the computing devices may utilize conventional network connectivity, such as Token Ring, Ethernet, WiFi or other conventional communications standards. Further, network 18 can comprise one or more of any type of network, including the Internet, a wide area network (WAN), a local area network (LAN), a virtual private network (VPN), etc. Where a computing device such as client 14 communicates via the Internet, connectivity could be provided by conventional TCP/IP sockets-based protocol, and client 14 could utilize an Internet service provider to establish connectivity to network 18.

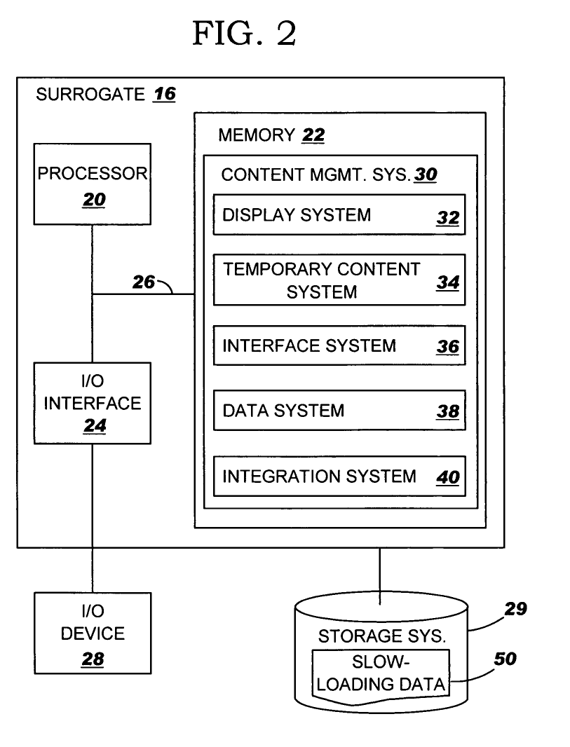

It is understood that each computing device can comprise any type of computing device such as a network server, a desktop computer, a laptop, a handheld device, a mobile phone, a pager, a personal data assistant, etc., that is capable of communicating with one or more other computing devices. For example, FIG. 2 shows a more detailed view of surrogate 16 according to one embodiment of the invention. In this case, content management system 30 is implemented on surrogate 16 as computer program code. To this extent, surrogate 16 is shown including a processor 20, a memory 22, an input/output (I/O) interface 24, and a bus 26. Further, surrogate 16 is shown in communication with an external I/O device/resource 28 and a storage system 29.

In general, processor 20 executes computer program code, such as content management system 30, that is stored in memory 22 and/or storage system 29. While executing computer program code (e.g., content management system 30), processor 20 can read and/or write data (e.g., slow-loading data 50) to/from memory 22, storage system 29, and/or I/O interface 24. Bus 26 provides a communication link between each of the components in surrogate 16, while I/O device 28 comprises a device that enables a user to interact with surrogate 16 (e.g., keyboard, pointing device, display, etc.), and/or a device that enables surrogate 16 to communicate with one or more other computing devices such as client 14 shown in FIG. 1 (e.g., network adapter, I/O port, modem, etc.).

Surrogate 16 is only representative of various possible combinations of hardware. For example, processor 20 may comprise a single processing unit, or be distributed across one or more processing units in one or more locations, e.g., on a client and server. Similarly, memory 22 and/or storage system 29 can comprise any combination of various types of data storage and/or transmission media that reside at one or more physical locations. Further, I/O interface 24 can comprise any system for exchanging information with one or more I/O devices 28. Still further, it is understood that one or more additional components (e.g., system software, math co-processor, etc.) not shown in FIG. 2 can be included in surrogate 16.

It is understood that the other computing devices shown in FIG. 1 (content provider 12, client 14, and data source 20) also typically include the same hardware elements as shown in FIG. 2 for surrogate 16 (e.g., CPU, memory, I/O interface, etc.). These have not been separately shown and discussed for brevity. However, if a computing device, such as client 14, comprises a handheld device or the like, it is understood that one or more I/O devices 28 (e.g., a display) and/or storage system 29 could be contained within the computing device, not externally as shown.

As discussed above, content management system 30 obtains display content from content provider 12 (FIG. 1) and/or slow-loading data 50 from data source 20 (FIG. 1) and/or storage system 29. Subsequently, content management system 30 performs any necessary processing before providing the display content for display at client 14 (FIG. 1). In particular, when display content includes an indication that slow-loading data 50 is to be incorporated, content management system 30 can generate temporary content that is provided for display at client 14 while slow-loading data 50 is obtained/processed. Once slow-loading data 50 is available, content management system 30 can provide it to client 14 for display.

To this extent, content management system 30 is shown including a display system 32 for obtaining display content, a temporary content system 34 for generating temporary content, an interface system 36 for providing the temporary content for display at client 14 (FIG. 1), a data system 38 for obtaining slow-loading data 50, and an integration system 40 for generating complete content based on the display content and slow-loading data 50. Operation of each of these systems is discussed further below. However, it is understood that some of the various systems shown included in content management system 30 can be implemented independently, combined, and/or stored in memory for one or more separate servers that communicate over a network. Further, it is understood that some of the systems and/or functionality may not be implemented or additional systems and/or functionality may be included.

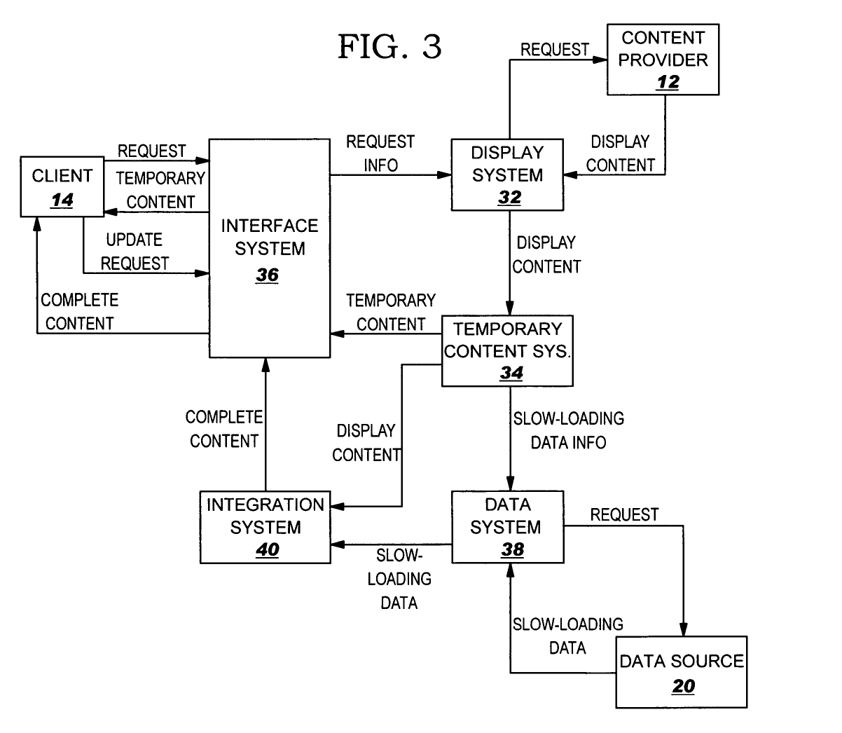

FIG. 3 shows an illustrative data flow diagram for the various systems in content management system 30 and system 10 (FIG. 1). Initially, user 22 (FIG. 1) can operate client 14 to generate a request for display content. The request is forwarded to content management system 30 (FIG. 1) and can be received by interface system 36. The request can comprise any type of message that requests data. For example, the request can comprise an address for a web page or the like. In any event, interface system 36 can process the request and forward request information to display system 32.

Display system 32 can obtain the display content from content provider 12 based on the request information. In particular, display system 32 can request the display content from content provider 12, which can provide the display content in response. In this case, display system 32 will receive the display content, and determine if the display content requires the incorporation of slow-loading data. When the display content does not require any slow-loading data, display system 32 can forward the display content to interface system 36, which can provide the display content for display at client 14.

However, when slow-loading data is to be incorporated into the display content, display system 32 can provide the display content to temporary content system 34 for further processing. The display content can use any solution for identifying slow-loading content to be incorporated. In one embodiment, the display content includes a tag that indicates the slow-loading data to be incorporated into the display content. The tag can identify the location of the slow-loading data, one or more operations (e.g., calculations) to be performed on data to generate the slow-loading data, etc. Additionally, the tag can include a placeholder that comprises display data that is temporarily inserted into the display content in place of the slow-loading data, and/or a time period that obtaining the slow-loading data is expected to take.

In any event, temporary content system 34 can generate temporary content for display at client 14 by replacing the tag in the display content with a placeholder. As mentioned above, the placeholder can be included in the display content or a standard placeholder (e.g., “Please wait, the page is loading . . . ”) can be inserted in place of the tag. Additionally, temporary content system 34 can add an indicator, such as a meta refresh tag or the like, to the temporary content. The indicator can signal client 14 to generate an update request for the display content. Further, the indicator can include a time period that client 14 should wait before generating the update request. The time period can be based on the time period that obtaining the slow-loading data is expected to take. In one embodiment, temporary content system 34 can adaptively determine the time period based on the amount of time that previous requests for the same slow-loading data, slow-loading data from the same source, and/or slow-loading data requiring similar processing have taken. For example, temporary content system 34 can maintain and use a running average of the ten most recent requests for the slow-loading data, or the like. Regardless, temporary content system 34 can provide the temporary content to interface system 36, which can provide the temporary content over network 18 (FIG. 1) for display at client 14.

Temporary content system 34 can further provide information on obtaining the slow-loading data to data system 38. The information can comprise the portion of the tag that identifies the source and/or processing required to obtain the slow-loading data. In any event, data system 38 can then request the slow-loading data from data source 20. As previously shown, data source 20 can be remotely located (e.g., FIG. 1), be implemented within stored in storage system 29 (FIG. 2) at surrogate 16 (FIG. 2), or the like. In any event, data system 38 can request the slow-loading data from data source 20. In response to the request, data source 20 can process data to generate the slow-loading data and/or provide the slow-loading data to data system 38.

Data system 38 can provide the slow-loading data to integration system 40, and temporary content system 34 can provide the display content to integration system 40. Integration system 40 will generate complete content based on the slow-loading data and the display content. For example, integration system 40 can replace the tag in the display content with the slow-loading data using any known solution. In any event, when interface system 36 receives an update request for the display content from client 14, integration system 40 can provide the complete content to interface system 36, which can provide the complete content for display at client 14.

It is understood that numerous variations are possible. For example, the complete content may not be available when the update request is received from client 14. In this case, interface system 36 can again provide temporary content that includes the indicator and/or time period so that client 14 will generate another update request. Similarly, the display content may comprise a plurality of tags indicating slow-loading data. In this case, the time period included in the temporary content can be selected based on the shortest expected time (more responsive), the longest expected time (fewer requests), or the like. Additionally, when an update request is received before all of the slow-loading data has been obtained, integration system 14 can provide temporary content that includes the slow-loading data already obtained and one or more placeholders for the remaining slow-loading data. Still further, it is understood that display content can be provided to client 14 without the use of surrogate 16 (FIG. 1). For example, content management system 30 (FIG. 1) could be implemented on content provider 12, client 14, etc. When implemented on client 14, it is understood that the temporary content and/or complete content would be provided for display at client 14 without the use of a network as discussed above.

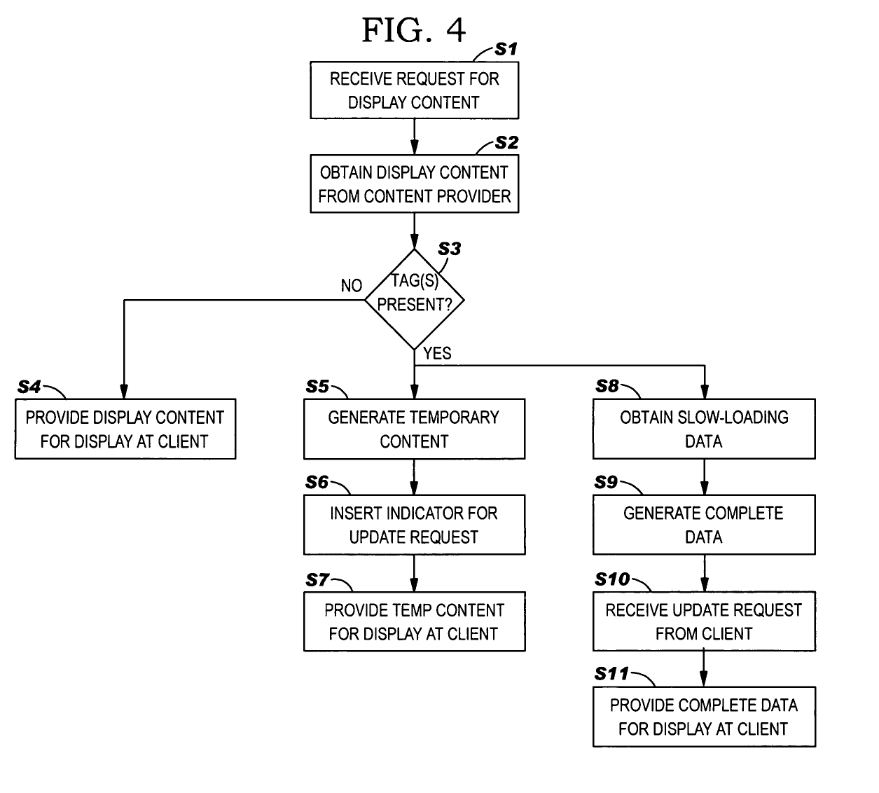

In any event, FIG. 4 shows method steps that can be performed by the various systems shown in FIG. 3 when processing a request for display content according to one embodiment of the invention. In step S1, interface system 36 (FIG. 3) receives a request for the display content from client 14, and in step S2, display system 32 obtains the display content from content provider 12. In step S3, display system 32 determines if one or more tags are present in the display content. When no tags are present, then in step S4, interface system 36 provides the display content for display at client 14.

When one or more tags are present, then in step S5, temporary content system 34 generates temporary content, and in step S6, temporary content system 34 inserts an indicator for client 14 to generate an update request. In step S7, interface system 36 provides the temporary content for display at client 14. Additionally, in step S8, data system 38 obtains slow-loading data from data source 20. Subsequently, in step S9, integration system 40 generates complete data based on the display content and the slow-loading data. In step S10, interface system 36 receives an update request for the display content from client 14, and in step S11, interface system 36 provides the complete content for display at client 14.

Various additional steps and/or enhancements can be performed in alternative embodiments of the invention. For example, prior to step S1, a developer such as a web page author generates the display content and can include one or more tags in the display content. Subsequently, the display content is deployed to content provider 12 (FIG. 3). Additionally, display system 32 (FIG. 3) can use a marker, such as a HyperText Transport Protocol (HTTP) header, to determine if it should parse the display content for the presence of one or more tags, or merely forward the display content for display at client 14 (FIG. 3). Further, the display and/or temporary content can be cached on surrogate 16 (FIG. 1) for quicker processing once the slow-loading data has been obtained. Still further, when surrogate 16 is providing display content to multiple clients 14, it is understood that the display content for each client 14 can be indexed using a client-specific identifier or the like to ensure that the display content is routed appropriately.

It should be appreciated that the teachings of the present invention could be offered as a business method on a subscription or fee basis. For example, surrogate 16 (FIG. 1) and/or content management system 30 (FIG. 1) could be created, maintained, supported and/or deployed by a service provider that offers the functions described herein for customers. That is, a service provider could offer to provide content over a network as described above. It is understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized.

The present invention also can be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of providing content over a network, the method comprising:
receiving display content over the network, wherein the display content includes a tag that indicates slow-loading data to be incorporated into the display content;
generating temporary content by replacing the tag in the display content with a placeholder; and
providing the temporary content for display at a client.

2. The method of claim 1, further comprising adding an indicator to the temporary content, wherein the indicator signals the client to generate an update request for the display content.

3. The method of claim 2, wherein the indicator further includes a time period before the update request should be generated.

4. The method of claim 1, further comprising requesting the slow-loading data from a data source.

5. The method of claim 1, further comprising receiving a request for the display content from the client.

6. The method of claim 1, further comprising requesting the display content from a content provider.

7. The method of claim 1, further comprising receiving the slow-loading data from a data source over the network.

8. The method of claim 7, further comprising generating complete content based on the display data and the slow-loading data.

9. The method of claim 8, further comprising:
receiving an update request for the display content from the client; and
providing the complete content for display at the client.

10. A method of providing content over a network, the method comprising:
receiving display content from a content provider, wherein the display content includes a tag that indicates slow-loading data to be incorporated into the display content;
generating temporary content by replacing the tag in the display content with a placeholder;
providing the temporary content over the network for display at a client;
receiving the slow-loading data from a data source;
generating complete content based on the display content and the slow-loading data; and
providing the complete content over the network for display at the client.

11. The method of claim 10, further comprising inserting an indicator in the temporary content, wherein the indicator signals the client to generate an update request for the display content.

12. The method of claim 10, further comprising receiving an update request from the client, wherein the providing the complete content step is performed in response to the update request.

13. The method of claim 10, further comprising requesting the slow-loading data from a data source.

14. The method of claim 10, further comprising:
receiving a request for the display content from the client; and
requesting the display content from the content provider.

15. A system for providing content over a network, the system comprising:
a display system for receiving display content over the network, wherein the display content includes a tag that indicates slow-loading data to be incorporated into the display content;
a temporary content system for generating temporary content by replacing the tag in the display content with a placeholder; and
an interface system for providing the temporary content for display at a client.

16. The system of claim 15, further comprising a data system for receiving the slow-loading data from a data source.

17. The system of claim 15, further comprising an integration system for generating complete content based on the display content and the slow-loading data.

18. The system of claim 17, wherein the interface system further provides the complete content for display at the client.

19. The system of claim 15, wherein the interface system further receives an update request for the display content from the client.

20. A program product stored on a recordable medium for providing content over a network, the program product comprising:
program code for receiving display content, wherein the display content includes a tag that indicates slow-loading data to be incorporated into the display content;
program code for generating temporary content by replacing the tag in the display content with a placeholder; and
program code for providing the temporary content over the network for display at a client.

21. The program product of claim 20, further comprising program code for receiving the slow-loading data over the network from a data source.

22. The program product of claim 20, further comprising program code for generating complete content based on the display content and the slow-loading data.

23. The program product of claim 22, further comprising:
program code for receiving an update request for the display content from the client; and
program code for providing the complete content for display at the client.

24. A method of deploying an application for providing content over a network, the method comprising:
providing a computer infrastructure being operable to:
receive display content, wherein the display content includes a tag that indicates slow-loading data to be incorporated into the display content;
generate temporary content by replacing the tag in the display content with a placeholder;
provide the temporary content over the network for display at a client;
receive the slow-loading data;
generate complete content based on the display content and the slow-loading data; and
provide the complete content over the network for display at the client.

25. Computer software embodied in a propagated signal for providing content over a network, the computer software comprising instructions to cause a computer system to perform the following functions:
receive display content, wherein the display content includes a tag that indicates slow-loading data to be incorporated into the display content;
generate temporary content by replacing the tag in the display content with a placeholder;
provide the temporary content over the network for display at a client;
receive the slow-loading data;
generate complete content based on the display content and the slow-loading data; and
provide the complete content over the network for display at the client.
